(19) United States
(12) Patent Application Publication
(10) Pub. No.: US 2005/0217937 A1
(43) Pub. Date: Oct. 6, 2005

(54) Retractable safety device

(76) Inventor: Bradley A. Rohlf, North St. Paul, MN (US)

Correspondence Address: IPLM Group, P.A., Post Office Box 18455, Minneapolis, MN, 55418, US

(21) Appl. No.: 10/818,172

(22) Filed: Apr. 5, 2004

(51) Int. Cl. A62B 1/08

(52) U.S. Cl. 182/232

(57) ABSTRACT

A preferred embodiment lanyard for interconnecting a safety harness worn by a user and an anchorage point includes a line and a retracting device. The line has a first end, a second end, and an intermediate portion. The first end is releasably connectable to the safety harness, and the second end is releasably connectable to the anchorage point. The retracting device includes a housing, a drum, and a biasing member. The biasing member interconnects the housing and the drum, and the drum is continually biased by the biasing member. The drum is rotatable relative to the housing. The intermediate portion is wound about the drum from two sides of the drum, wherein the intermediate portion is paid out and retracted from the two sides of the drum. The retracting device is non-load bearing should a fall occur.

### BACKGROUND OF THE INVENTION

1. Field of the Invention

The present invention relates to a retractable safety device, more particularly, a retractable lanyard for interconnecting a safety harness worn by a user and an anchorage point.

2. Description of the Prior Art

Various occupations place people in precarious positions at relatively dangerous heights thereby creating a need for fall protection and fall arrest apparatus. Among other things, such apparatus usually include an interconnection between an anchorage point and a safety harness worn by a user performing tasks in proximity to the anchorage point. One type of interconnection commonly used is a lanyard.

As the user is performing tasks, there is a risk that the lanyard could become a fall hazard for the user. There is also a risk that the lanyard could interfere with the performance of the user. Therefore, there is a need for a lanyard that will reduce these risks.

### SUMMARY OF THE INVENTION

A preferred embodiment lanyard for interconnecting a safety harness worn by a user and an anchorage point includes a line and a retracting device. The line has a first end, a second end, and an intermediate portion. The first end is releasably connectable to the safety harness, and the second end is releasably connectable to the anchorage point. The retracting device includes a housing, a drum, and a biasing member. The biasing member interconnects the housing and the drum. The drum is continually biased by the biasing member, and the drum is rotatable relative to the housing. The intermediate portion is wound about the drum from two sides of the drum. The intermediate portion is paid out and retracted from the two sides of the drum, and the retracting device is non-load bearing should a fall occur.

A preferred embodiment lanyard for interconnecting a safety harness worn by a user and an anchorage point includes a line, a drum, a housing, and a biasing member. The line has a first end, a second end, and an intermediate portion. The first end is releasably connectable to the safety harness, and the second end is releasably connectable to the anchorage point. The drum has a slot through which the line is inserted, and the drum divides the intermediate portion into a first portion and a second portion. The housing has a hub on which the drum is rotatably connected. The biasing member interconnects the housing and the drum. The drum is continually biased by the biasing member, and the drum is rotatable relative to the housing. The first portion and the second portion are concurrently paid out and retracted from both sides of the drum, and the drum is slidable along the line when the line is unwound from the drum.

A preferred embodiment lanyard for interconnecting a safety harness worn by a user and an anchorage point includes a line and retracting means. The line has a first end, a second end, and an intermediate portion. The first end is releasably connectable to the safety harness, and the second end is releasably connectable to the anchorage point. The retracting means automatically retracts the line when the line has been paid out and there is slack in the line. The line is paid out and retracted from both sides of the retracting means. The line is load bearing and the retracting means is non-load bearing should a fall occur.

### BRIEF DESCRIPTION OF THE DRAWINGS

FIG. 1 is an exploded perspective view of a retractable lanyard constructed according to the principles of the present invention;

FIG. 2 in another exploded perspective view of the retractable lanyard shown in FIG. 1;

FIG. 3 is a cross section view of the retractable lanyard shown in FIG. 1 with the line engaging the drum and paid out of the housing;

FIG. 4 is a cross section view of the retractable lanyard shown in FIG. 1 with the line wound about the drum and stored within the housing;

FIG. 5 is a side view of the retractable lanyard shown in FIG. 1 with the line paid out of the housing;

FIG. 6 is a side view of the retractable lanyard shown in FIG. 1 with the line stored within the housing; and

FIG. 7 shows the retractable lanyard shown in FIG. 1 interconnecting a safety harness worn by a user and an anchorage point.

### DETAILED DESCRIPTION OF A PREFERRED EMBODIMENT

A preferred embodiment retractable lanyard constructed according to the principles of the present invention is represented by the numeral 100 in the drawings.

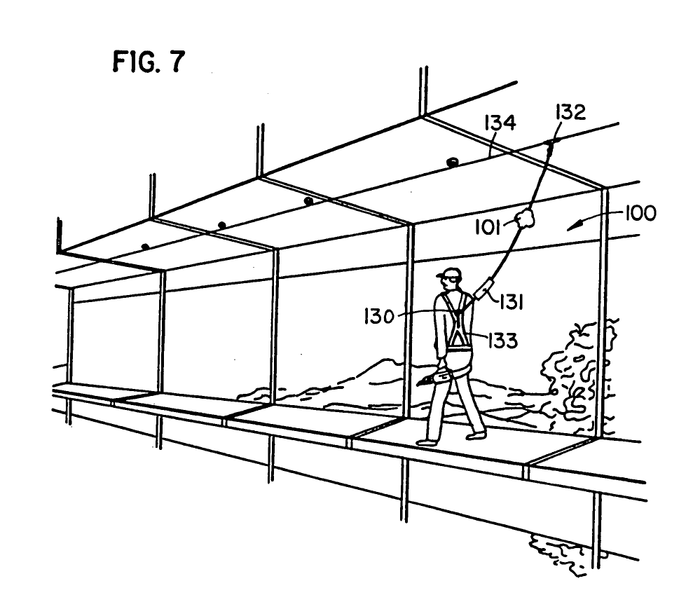

The retractable lanyard 100 includes a retracting device 101 and a line 102. The line 102 is preferably made of polyester webbing, but it is recognized that any suitable line well known in the art may be used. The lanyard 100 interconnects a safety harness 133 donned by a user and an anchorage point 134, as shown in FIG. 7, for use as fall protection and fall arrest. The anchorage point could be a horizontal lifeline (as shown), a support structure, or other suitable anchorage point well known in the art of fall protection and fall arrest.

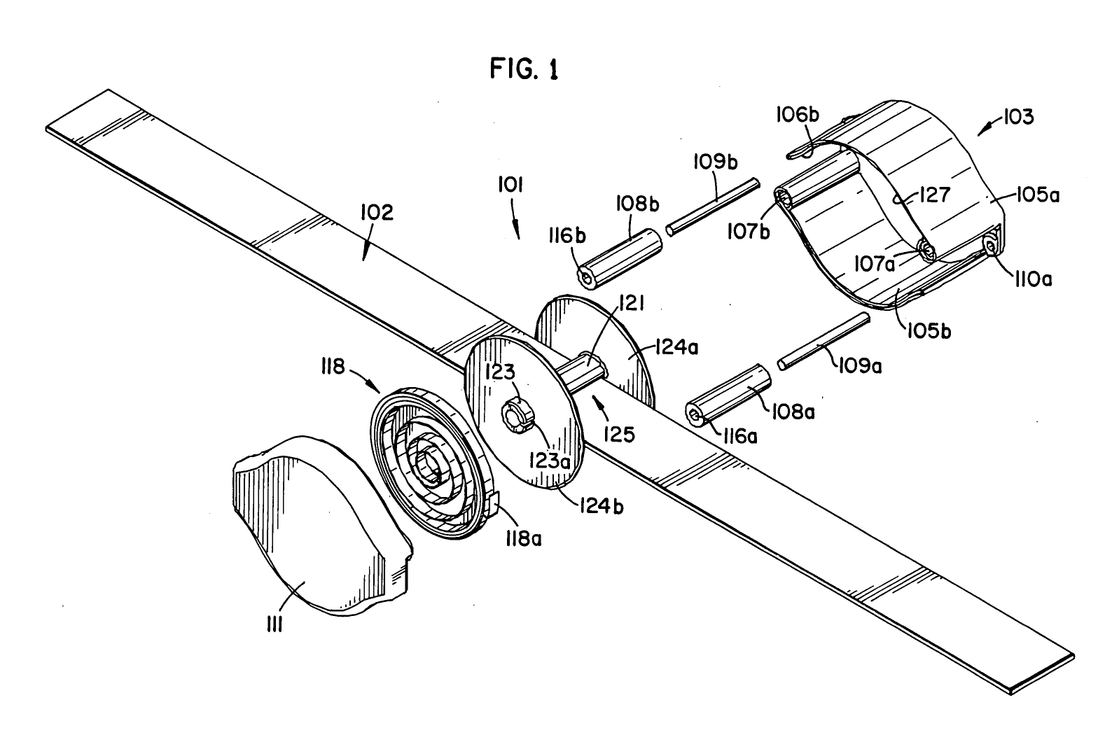

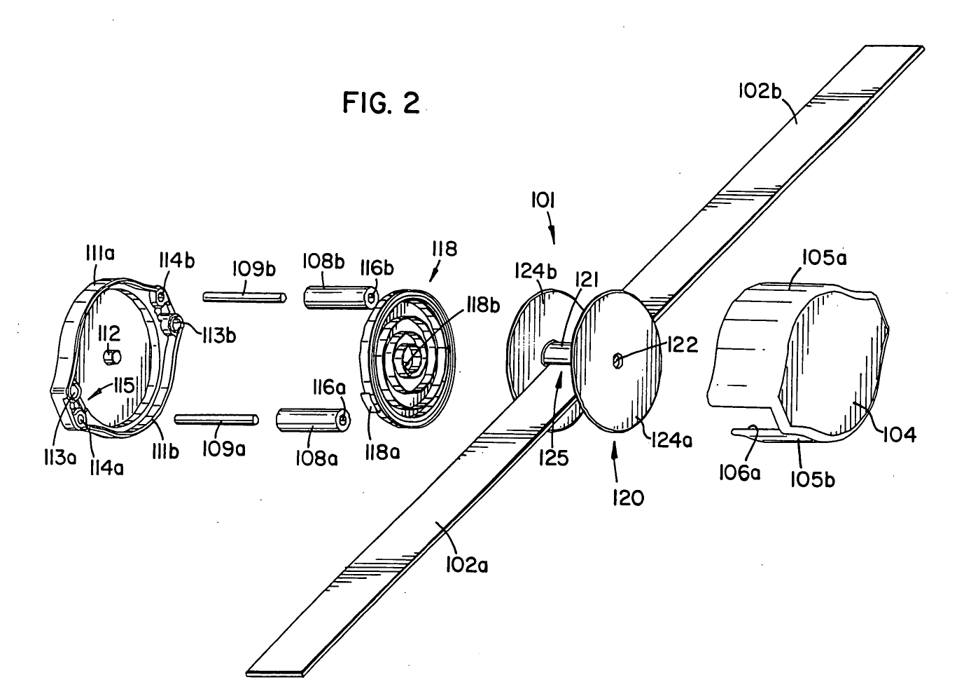

As shown in FIGS. 1 and 2, the retracting device 101 includes a housing 103 having a front 104, sides 105a and 105b, and a back 111. The sides 105a and 105b are operatively connected to the front 104. Side 105a extends outward from the top of the front 104, and side 105b extends outward from the bottom of the front 104. The front 104 and the sides 105a and 105b define a cavity 127 proximate the inner surface of the front 104. Slots 106a and 106b separate the sides 105a and 105b. The slot 106a is proximate the left side of the housing 103, and the slot 106b is proximate the right side of the housing 103.

The left side of the housing 103 includes a bore 107a and an indent 10a proximate the cavity 127. The bore 107a extends outward from the front 104 along the end of the side 105a proximate the top of the slot 106a. The indent 110a is proximate the end of the side 105b and the bottom of the slot 106a. The right side of the housing 103 includes a bore 107b and an indent (not shown) proximate the cavity 127. The bore 107b extends outward from the front 104 along the end of the side 105b proximate the bottom of the slot 106b. The indent, similar to indent 110a, is proximate the end of the side 105a and the top of the slot 106b. These are shown in FIG. 1.

The back 111, shown in FIG. 2, includes a top 111a, a bottom 111b, and a hub 112. The hub 112 extends outward from the inner surface of the back 111 proximate the middle of the back 111. The top 111a and the bottom 111b are separated by a bore 113a, an indent 114a, and a slot 115 on the left side of the back 111 and a bore 113b and an indent 114b on the right side of the back 111. The bore 113a is incorporated into the back 111 proximate the top 111a, and the indent 114a is incorporated into the back 111 proximate the bottom 111b. The slot 115 is also incorporated into the back 111 proximate the inner side of the indent 114a. The bore 113b is incorporated into the back 111 proximate the bottom 111b, and the indent 114b is incorporated into the back 111 proximate the top 111a.

The bore 113a of the back 111 corresponds with the bore 107a of the front 104, and the bore 113b of the back corresponds with the bore 107b of the front 104. The indent 114a of the back 111 corresponds with the indent 110a of the front 104, and the indent 114b of the back 111 corresponds with the indent (not shown) of the front 104. The indents are configured and arranged to engage the ends of fasteners 109a and 109b, which are preferably rods, inserted through bores 116a and 116b of rollers 108a and 108b. In other words, roller 108a extends between indents 114a and 110a, and roller 108b extends between indent 114b and the corresponding indent of the front 104. Alternatively, the indents could be apertures through which rivets (fasteners 109a and 109b) could be inserted, extending through the housing 103 and riveted on the outsides of the front 104 and the back 111. Using rivets would assist in connecting the front 104 and the back 111.

A spool 120 includes a hollow cylindrical drum 121 and disk-shaped sides 124a and 124b operatively connected to each end of the drum 121. The spool 120 also includes a bore 122 extending through the drum 121 and the sides 124a and 124b. Side 124a faces the front 104, and side 124b faces the back 111 and includes a flange 123 extending outward about the bore 122. The flange 123 includes a slot 123a interrupting the flange 123 and providing access to the bore 122. The flange 123 accommodates the hub 112 of the back 111, which is inserted into the bore 122. The spool 120 is rotatable about the hub 112. A longitudinal slot 125 extends through the drum 121 between the sides 124a and 124b, and the line 102 is threaded through the slot 125. The drum 121 divides the line 102 into a first portion 102a and a second portion 102b. The line 102 is preferably not secured to the drum 121 so that the line 102 may be slid through the slot 125 thereby redefining the lengths of the first portion 102a and the second portion 102b. However, it is recognized that the line 102 may be secured to the drum 121.

A biasing member 118, preferably a motor spring, includes a first end 118a, which is the outer end, and a second end 118b, which is the inner end. The first end 118a is inserted into and engaged by the slot 115 of the back 111. The second end 118b is inserted into and engaged by the slot 123a of the spool 120. Because the housing 103 is relatively stationary and the spool 120 is rotatable about the hub 112, the biasing member 118 uni-directionally continually biases the spool 120 about the hub 112. The biasing member 118 exerts a constant force upon the spool 120 because the biasing member 118 wants to unwind to uni-directionally rotate the spool 120 about the hub 112.

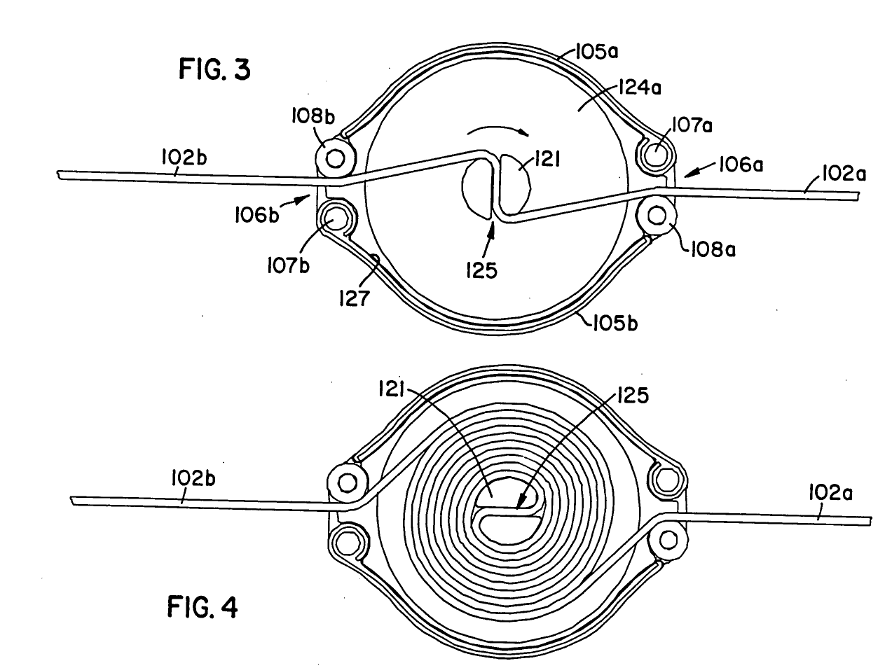

When the line 102 is wound about the drum 121, as shown in FIG. 4, the first portion 102a and the second portion 102b are wound about the drum 121 in the same direction, as shown in FIG. 3. The first portion 102a extends through the first slot 106a from proximate the bottom of the housing 103, and the second portion 102b extends through the second slot 106b from proximate the top of the housing 103. The portions 102a and 102b are concurrently paid out and wound about the drum 121. The roller 108a rotates and acts as a wear pad as the first portion 102a moves in and out of the housing 103, and roller 108b rotates and acts as a wear pad as the second portion 102b moves in and out of the housing 103.

Assembled, the line 102 extends through the slot 125 of the spool 120, and the hub 112 of the back 111 is inserted into the bore 122 of the spool 120. The biasing member 118 interconnects the non-rotatable housing 103 and the rotatable spool 120, rotatable about the hub 112 of the housing 103. The rollers 108a and 108b are carried by the fasteners 109a and 109b, respectively, extending between the front 104 and the back 111 of the housing 103. The front 104 includes a groove along the edges of the sides 105a and 105b that engages a ridge along the edge of the back 111 to connect the front 104 and the back 111. The front 104 and the back 111 are preferably connected by ultrasonic welding along the seam between the front 104 and the back 111, and if rivets are used, the rivets also assist in connecting the housing 103. The first portion 102a and the second portion 102b of the line 102 pass through the slots 106a and 106b, respectively. The biasing member 118 continually biases the spool 120 to retract any slack line 102 into the housing 103.

The housing 103 contains the spool 120 and the biasing member 118 within the cavity 127, and each end of the line 102 extends through the opposing slots 106a and 106b in the housing 103. Because the line 102 is preferably not fixedly connected to the drum 121 or the housing 103, neither the drum 121 nor the housing 103 is load bearing. Should a fall occur, the line 102 is pulled out of the housing 103 until the line 102 is completely unwound from the drum 121. The line 102 and the optional shock absorber 131 are subjected to the load from the fall. Therefore, the drum 121 and the housing 103 can be made of a light weight material such as plastic since they are not load bearing, and this allows the lanyard 100 to be compact and very light weight.

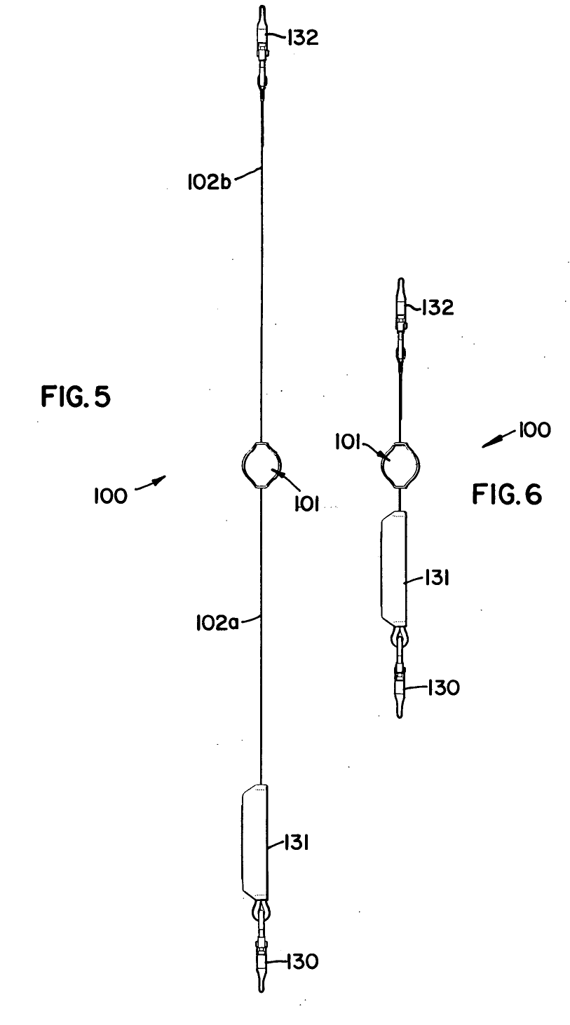

As shown in FIG. 7, a hook 130 releasably connects the end of the first portion 102a to a safety harness 133 and a hook 132 releasably connects the end of the second portion 102b to an anchorage point 134 such as a horizontal lifeline. An optional shock absorber 131 may be included preferably proximate the hook 130, as shown in FIGS. 5 and 6. An intermediate portion of the line 102 is between the ends of the portions 102a and 102b and is operational with the retracting device 101.

The lanyard 100 is slidable along the length of the lifeline thereby enabling the user to move along the length of the lifeline. The retracting device 101 stores the webbing 102 within the housing 103 until the webbing 102 is paid out by the user moving away from the anchorage point 134. Because the line 102 is urged to be wound about the drum 121 by the biasing member 118, the biasing member 118 placing a constant force upon the drum 121, the line 102 pays out as the user moves away from the lifeline and retracts as the user moves toward the lifeline. When there is some slack in the line 102, the line 102 is wound about the drum 121 by the biasing member 118. This reduces the risk that the line 102 will interfere with the user while performing tasks. FIGS. 3 and 5 show the line 102 paid out of the housing 103 and FIGS. 4 and 6 show the line 102 retracted into the housing 103. The first portion 102a and the second portion 102b of the line 102 on either side of the drum 121 are paid out of the housing 103 and wound about the drum 121 concurrently. The force of the biasing member 118 on the spool 120 can be overcome to unwind the line 102 from the drum 121, but once there is slack in the line 102, biasing member 118 causes the line 102 to wind about the drum 121.

In operation, when the user moves away from the anchorage point, the line 102 is drawn or paid out of the housing 103, as shown in FIG. 5. As the line 102 is being paid out, the spool 120 rotates about the hub 112 causing the biasing member 118 to wind more tightly about the flange 123 within the cavity 127. Both portions 102a and 102b are paid out concurrently from the housing 103. If the line 102 is paid out completely so that none of the line 102 is wound about the drum 121, as shown in FIG. 3, the drum 121 may be slid along the length of the line 102 to reposition the retracting device 101 along the line 102.

Repositioning the retracting device 101 along the line 102 may be desirable when the user is performing tasks in one location and prefers some slack in the line 102 without the line 102 being retracted. For example, if the retracting device 101 is repositioned more proximate the shock absorber 131, the shock absorber 131 will stop the line 102 from retracting when the shock absorber 131 reaches the housing 103. Similarly, if the retracting device 101 is repositioned more proximate the hook 132, the stitching securing the line 102 to the hook 132 will stop the line 102 from retracting when the stitching reaches the housing 103.

Should a fall occur, the line 102 will be paid out completely and the retracting device 101 will not be subjected to a significant load due to the force of the fall. In other words, the tension in the line 102 due to the load of the fall is not transferred to the retracting device 101. The retracting device 101 basically rides on the line 102 rather than terminates at the line 102 as does a retracting device of a typical self-retracting lifeline. Therefore, because the retracting device 101 is not load bearing, meaning that the retracting device 101 is not subjected to the load of the fall, it can be made of a light weight material such as plastic.

When the user moves toward the anchorage point, the tension on the line 102 is reduced thereby creating some slack in the line 102. Because the force of the biasing member 118 wants to unwind or uncoil to become less tightly wound about the flange 123, the spool 120 rotates in an opposite direction about the hub 112 as when the line 102 was being paid out thereby retracting and winding the line 102 about the drum 121, as shown in FIGS. 4 and 6. The line 102 is thereby automatically retracted or recoiled into the retracting device 101. No physical winding or reeling of the line 102 is required by the user of the retractable lanyard 100.

The above specification, examples and data provide a complete description of the manufacture and use of the composition of the invention. Since many embodiments of the invention can be made without departing from the spirit and scope of the invention, the invention resides in the claims hereinafter appended.

1. A lanyard for interconnecting a safety harness worn by a user and an anchorage point, comprising:
a) a line having a first end, a second end, and an intermediate portion, the first end being releasably connectable to the safety harness, the second end being releasably connectable to the anchorage point; and
b) a retracting device including a housing, a drum, and a biasing member, the biasing member interconnecting the housing and the drum, the drum being continually biased by the biasing member, the drum being rotatable relative to the housing, the intermediate portion being wound about the drum from two sides of the drum, wherein the intermediate portion is paid out and retracted from the two sides of the drum, and wherein the retracting device is non-load bearing should a fall occur.

2. The lanyard of claim 1, wherein the line is made of webbing.

3. The lanyard of claim 1, wherein the biasing member is a motor spring.

4. The lanyard of claim 1, further comprising a slot in the drum, the line being inserted trough the slot, the drum being slidable along the line when the line is unwound from the drum.

5. The lanyard of claim 1, further comprising a hub operatively connected to the housing, the drum being rotatably connected to the hub.

6. The lanyard of claim 1, wherein the intermediate portion includes a first portion on one side of the drum and a second portion on another side of the drum, the first portion and the second portion being concurrently paid out and retracted from the two sides of the drum.

7. A lanyard for interconnecting a safety harness worn by a user and an anchorage point, comprising:
a) a line having a first end, a second end, and an intermediate portion, the first end being releasably connectable to the safety harness, the second end being releasably connectable to the anchorage point;
b) a drum having a slot through which the line is inserted, the drum dividing the intermediate portion into a first portion and a second portion;
c) a housing having a hub on which the drum is rotatably connected; and
d) a biasing member interconnecting the housing and the drum, the drum being continually biased by the biasing member, the drum being rotatable relative to the housing, the first portion and the second portion being concurrently paid out and retracted from both sides of the drum, the drum being slidable along the line when the line is unwound from the drum.

8. The lanyard of claim 7, wherein the drum is non-load bearing should a fall occur.

9. The lanyard of claim 7, wherein the line is made of webbing.

10. The lanyard of claim 7, wherein the biasing member is a motor spring.

11. A lanyard for interconnecting a safety harness worn by a user and an anchorage point, comprising:
a) a line having a first end, a second end, and an intermediate portion, the first end being releasably connectable to the safety harness, the second end being releasably connectable to the anchorage point; and
b) retracting means for automatically retracting the line when the line has been paid out and there is slack in the line, the line being paid out and retracted from both sides of the retracting means, the line being load bearing and the retracting means being non-load bearing should a fall occur.

12. The lanyard of claim 11, wherein the line is made of webbing.

13. The lanyard of claim 11, wherein the retracting means includes a housing, a drum, and a biasing member, the biasing member interconnecting the housing and the drum, the drum being continually biased by the biasing member, the drum being rotatable relative to the housing, the intermediate portion being wound about the drum from both sides of the drum, wherein the intermediate portion is paid out and retracted from both sides of the drum.

14. The lanyard of claim 13, further comprising a slot in the drum, the line being inserted through the slot, the drum being slidable along the line when the line is unwound from the drum.

15. The lanyard of claim 14, wherein the intermediate portion includes a first portion on one side of the drum and a second portion on another side of the drum, the first portion and the second portion being concurrently paid out and retracted from both sides of the drum.

16. A full protection safety assembly, comprising:
a) a safety harness;
b) an anchorage point;
c) a lanyard having a first end, a second end, and an intermediate portion, the first end having a first connector releasably connectable to the safety harness, the second end having a second connector releasably connectable to the anchorage point; and
d) a retracting device including a housing, a drum, and a biasing member, the biasing member interconnecting the housing and the drum, the drum being continually biased by the biasing member, the drum being rotatable relative to the housing, the intermediate portion being wound about the drum from two sides of the drum, wherein the intermediate portion is paid out and retracted from the two sides of the drum, and wherein the retracting device is non-load bearing should a fall occur.

17. The fall protection safety assembly of claim 16, further comprising a slot in the drum, the lanyard being inserted through the slot, the drum being slidable along the lanyard when the lanyard is unwound from the drum.

18. The fall protection safety assembly of claim 16, wherein the intermediate portion includes a first portion on one side of the drum and a second portion on another side of the drum, the first portion and the second portion being concurrently paid out and retracted from the two sides of the drum.

19. The fall protection safety assembly of claim 16, further comprising a hub operatively connected to the housing, the drum being rotatably connected to the hub.
